(19) United States
(12) Patent Application Publication
(10) Pub. No.: US 2011/0072512 A1
(43) Pub. Date: Mar. 24, 2011

(54) APPARATUS AND METHOD FOR PROVIDING COMMUNICATION SERVICE USING COMMON AUTHENTICATION

(75) Inventors: Dongguk JE, Daejeon (KR); Tae Yeon KIM, Daejeon (KR); Ho Young SONG, Daejeon (KR)

(73) Assignee: Electronics and Telecommunications Research Institute, Daejeon (KR)

(21) Appl. No.: 12/887,993

(22) Filed: Sep. 22, 2010

(30) Foreign Application Priority Data
Sep. 24, 2009 (KR) 10-2009-0090704
Aug. 17, 2010 (KR) 10-2010-0079382

(51) Int. Cl. H04L 9/00

(52) U.S. Cl. 726/21

(57) ABSTRACT

In an environment including a first service providing system and a second service providing system, the first service providing system forwards common authentication information received from a terminal to the second service providing system to perform authentication when the terminal that is located in a service provision area of the first service providing system and has requested connection is a visiting user. The first service providing system makes a connection request to the second service providing system based on the authentication result that is provided from the second service providing system based on the common authentication information. The second service providing system provides the communication service to the terminal by using the resources of the first service providing system.

### CROSS-REFERENCE TO RELATED APPLICATION

This application claims priority to and the benefit of Korean Patent Application No. 10-2009-0090704 and 10-2010-0079382 filed in the Korean Intellectual Property Office on Sep. 24, 2009 and Aug. 17, 2010, the entire contents of which are incorporated herein by reference.

### BACKGROUND OF THE INVENTION

(a) Field of the Invention

The present invention relates to an apparatus and method for providing a communication service using common authentication.

(b) Description of the Related Art

In general, communication service subscribers can use a communication service through a unique authentication procedure of a communication service provider. Also, communication services are not designed with mobility of a subscriber in mind. That is, a communication service provider provides a communication service to communication service subscribers only through locations or terminals specified by the service provider.

Thus, when the communication service subscriber moves out of a subscribed communication service area, the subscriber cannot use the communication service even if they are located within the service area of other service providers. For example, if one subscriber is subscribed to a communication service of provider A for home but uses a communication service of provider B in the office, a problem that the subscriber cannot use the subscribed communication service in the office arises.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention relates to a communication service providing service and a communication service providing method using the same, and more particularly, provides an apparatus and method for providing a communication service using common authentication that can provide a communication service to a communication service subscriber even in a communication service area of another service provider through authentication used commonly by each communication service.

In accordance with one aspect of the present invention, for achieving the technical advantages of the present invention, there is provided a method in which a first service providing system provides a communication service to a terminal in an environment including the first service providing system and a second service providing system, the method including:

receiving authentication information by a terminal that has requested connection; making a request to the terminal for common authentication information based on the received authentication information; receiving the common authentication information from the terminal and forwarding the same to the second service providing system; receiving an authentication result of the common authentication information from the second service providing system; and transmitting a connection permission message to the terminal based on the authentication result and making a request to the second service providing system for connection to the terminal so that the communication service is provided to the terminal through the second service providing system.

In accordance with another aspect of the present invention, for achieving the technical advantages of the present invention, there is provided a method for providing a communication service to a terminal in an environment including a first service providing system and a second service providing system, the method including:

the first service providing system determining whether a terminal that is located in a service provision area of the first service providing system and has requested connection is a visiting user; if the terminal is a visiting user, the first service providing system forwarding common authentication information received from the terminal to the second service providing system; the second service providing system performing authentication of the terminal based on the received common authentication information and sending an authentication result to the first service providing system; the first service providing system sending a connection permission message to the terminal based on the authentication result and making a connection request to the second service providing system; and the second service providing system providing the communication service to the terminal by using the resources of the first service providing system.

In accordance with still another aspect of the present invention, for achieving the technical advantages of the present invention, there is provided an apparatus for providing a communication service to a terminal using common authentication, the apparatus including:

a user authentication unit for determining whether the terminal is a visiting user based on authentication information received from the terminal, and if so, performing authentication based on common authentication information received from the terminal; and a service providing unit for providing a communication service to the terminal upon completion of the authentication of the terminal by the user authentication unit.

In accordance with yet another aspect of the present invention, for achieving the technical advantages of the present invention, there is provided a method for providing a communication service to a terminal in an environment including a first service providing system and a second service providing system, the method including:

requesting connection to the first service providing system, and then sending authentication information to the first service providing system; upon receiving a request for common authentication information from the first service providing system, sending common authentication information to the second service providing system through the first service providing system; and upon receiving a connection permission message from the first service providing system, receiving the communication service through the second service providing system.

In accordance with a further aspect of the present invention, for achieving the technical advantages of the present invention, there is provided a terminal for receiving a communication service through a second providing system in an environment including a first service providing system and a second service providing system, the terminal including:

an authentication information providing unit for providing authentication information to the first service providing system upon connection to the first service providing system; a common authentication information providing unit for, upon receiving a request for common authentication information from the first service providing system, transmitting common authentication information to the first service providing system to be forwarded to the second service providing system; and a service receiving unit for receiving the communication service provided from the second service providing system.

### BRIEF DESCRIPTION OF THE DRAWINGS

FIG. 1 is an illustration showing a communication service providing environment according to an exemplary embodiment of the present invention.

FIG. 2 is a flowchart showing a general authentication and connection procedure.

FIG. 3 is a structural view of a communication service providing system according to the exemplary embodiment of the present invention.

FIG. 4 is a structural view of a terminal according to the exemplary embodiment of the present invention.

FIG. 5 is a flowchart showing a common authentication and connection procedure according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may designate a mobile station (MS), a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In the specification, a base station (BS) may designate an access point (AP), a radio access station (RAS), a node B, a base transceiver station (BTS), a mobile multihop relay (MMR)-BS, etc., and may include the entire or partial functions of the access point, the radio access station, the node B, the base transceiver station, the MMR-BS, etc.

Hereinafter, a method for providing a communication service to a communication service subscriber using communication authentication according to an exemplary embodiment of the present invention will be described with reference to the accompanying drawings.

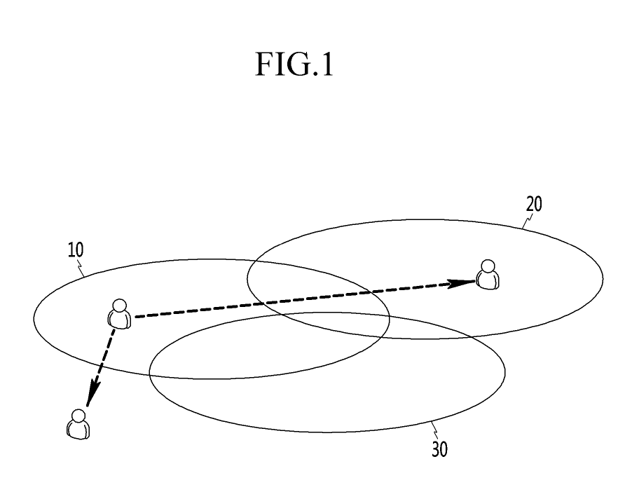

FIG. 1 is an illustration showing a communication service providing environment according to an exemplary embodiment of the present invention.

As shown in FIG. 1, a plurality of communication service areas 10, 20, and 30 where each communication service provider can provide communication services are located in close proximity to each other, and a communication service subscriber (hereinafter referred to as “subscriber” for convenience of explanation) receives a communication service while moving within the communication service areas or between the communication service areas.

Here, the communication service according to the exemplary embodiment of the present invention does not only involve a connection service, such as telephone, packet communication, or Internet, but also includes a content or application service that can be additionally connected to the connection service.

Conventionally, in the environment shown in FIG. 1, a user cannot receive a communication service that has been provided from a first communication service providing system in the service area of a second communication service providing system. However, in the exemplary embodiment of the present invention, even if the user who has received the service from the first communication service providing system is located in the second communication service area, they are allowed to continue receiving the communication service in the second service area as well through the first communication service providing system.

For example, it is assumed that a home service provider is a packet communication service provider, and a visiting service provider is an internet communication service provider. Also, it is assumed that a communication service provided to a user is an on-demand movie. In this case, when a user who watched an on-demand movie at home via packet access wants to continue watching the on-demand movie that they had watched at home in an environment (e.g., public place) other than their home and they connect to a public internet terminal, they can continue watching the on-demand movie at no extra charge.

In another example, it is assumed that a user is connected to a communication service providing system provided by an Internet service provider in the office in order to establish communication between the main office and the branch office, and receives a virtual private network service provided by a virtual private network service provider. Then, the user is able to connect to a telephone network provided by a telephone network service provider at home and receive the virtual private network service through the virtual private network service provider.

Prior to describing the exemplary embodiment of the present invention, a conventional authentication and connection procedure for providing a communication service will be described.

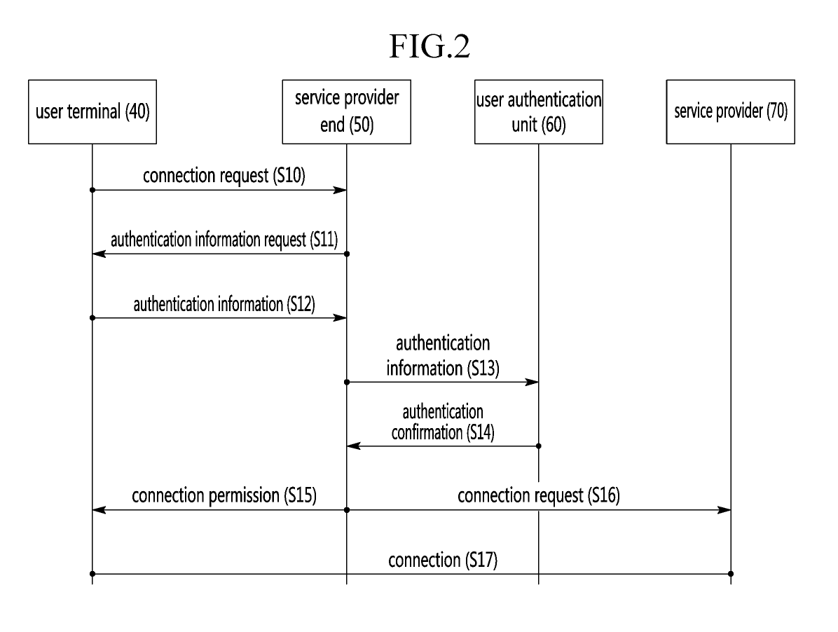

FIG. 2 is a flowchart showing a general authentication and connection procedure.

As shown in FIG. 2, a user terminal 40 requests connection to a service provider end 50 in order to receive a communication service (S10). Then, the service provider end 50 makes a request for authentication information to the user terminal 10 (S11). Hereupon, when the user terminal 40 transmits the requested authentication information to the service provider end 50 (S12), the service provider end 50 forwards the received authentication information to a user authentication unit 60 of the service provider (S13).

The user authentication unit 60 performs an authentication procedure based on previously registered user authentication information and the forwarded authentication information, and sends an authentication result to the service provider end 50 (S14). When authentication is confirmed in the user authentication unit 60, the service provider end 60 transmits a connection permission message to the user terminal 40 based on the authentication result (S15). Then, the service provider end 50 sends a service connection request message for the corresponding user to a service providing unit 70 (S16).

The user terminal 40 and the service providing unit 70 attempt connection based on the connection information, and perform the communication service (S17). Each communication service provider has a different user authentication procedure and method, and in general, their authentication procedures and methods are not compatible.

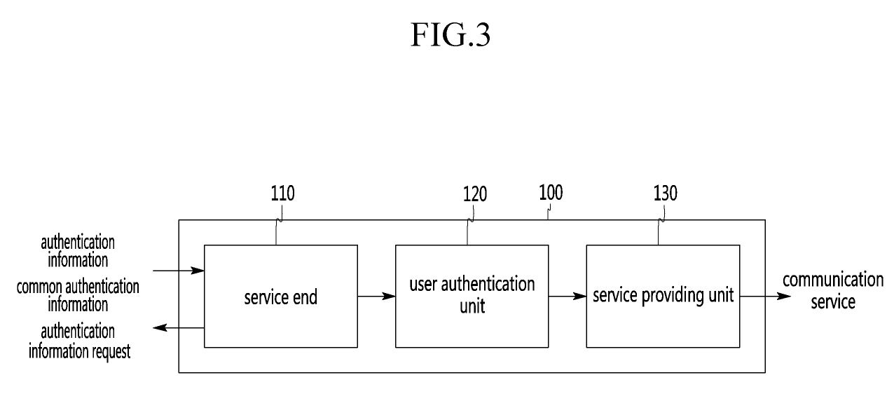

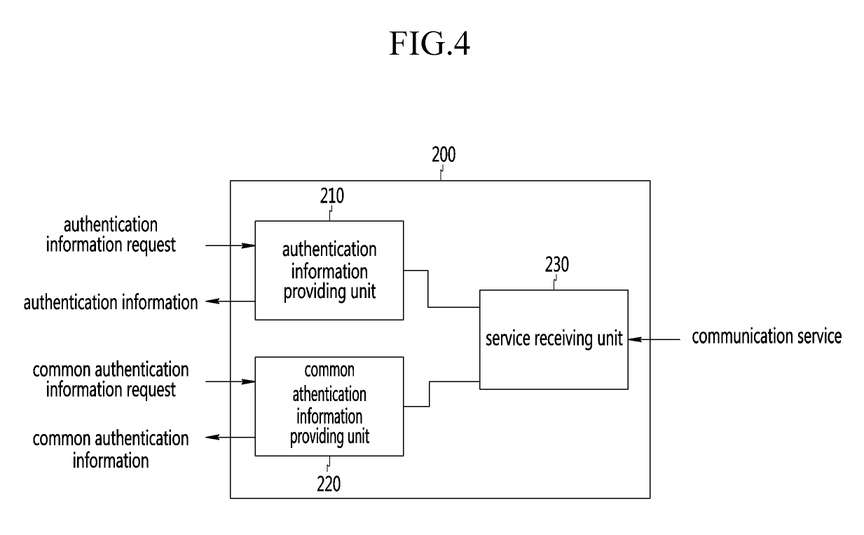

In the event that the authentication of a subscriber is performed and the subscriber connects to a service with this procedure, because each communication service provider has a different authentication procedure, the subscriber is not able to continually receive the provided service if they move to other service areas. Now, an authentication and connection procedure for providing a communication service to a communication service subscriber in a communication service providing system in accordance with the exemplary embodiment of the present invention will be described with reference to FIGS. 3 and 4.

FIG. 3 is a structural view of a communication service providing system according to the exemplary embodiment of the present invention.

As shown in FIG. 3, a communication service providing system 100 includes a service end 110, a user authentication unit 120, and a service providing unit 130.

The service end 110 receives a connection request message sent from a user terminal 200. Upon receipt of the connection request message, a request is made for authentication information of the user of the user terminal that has requested connection, and the authentication information is received from the user terminal 200 and forwarded to the user authentication unit 120. Here, the authentication information generally includes information used to authenticate a user who wants to receive a communication service.

Moreover, the service end 110 transmits a message indicative of permission of the user terminal 200 whose authentication is confirmed to the user terminal 200, and makes a request to the service providing unit 130 for connection to the user terminal 200 whose authentication is completed.

Based on the authentication information received from the service end 110, the user authentication unit 120 determines whether the user who has requested connection is a user (hereinafter referred to as “home service user” for convenience of explanation) that receives a communication service from the communication service providing unit 130, or a user (hereinafter referred to as “visiting service user” for convenience of explanation) that receives a communication service from another communication service providing unit 130.

In the case of a home service user, the authentication of user information is performed. That is, the user authentication unit 120 performs user authentication only for a home service provider. The authentication procedure as used here is identical to a general authentication procedure, so a detailed description will be omitted in the exemplary embodiment of the present invention.

However, if the user who has requested connection is a visiting service user as a result of determination of the user authentication unit 120, a request is made to the user terminal 200 for common authentication information of the user. The present invention will be described with respect to an example in which, when requesting the common authentication information, a request is made to the user terminal 200 through the user authentication unit 120, and the common authentication information includes a user identifier, a user authentication code (e.g., encryption code), or a subscription service provider identifier, but this invention is not necessarily limited thereto.

That is, the common authentication information is composed of a small an amount of information, which is an undeletable common part selected from among the authentication information of actual service providers, so as to minimize inconsistency of information between the service providers. Also, an authentication procedure of the received common authentication information is performed as well.

Upon receiving a request from the user authentication unit 120 to provide the service to the user who has succeeded in authentication, the service providing unit 130 provides the service to the corresponding user. Also, in order to provide the service to a visiting service user, resource information used in a home service providing apparatus is provided.

The service end 110 of the service providing system 100 according to the exemplary embodiment of the present invention may be a telephone station in wired communication or a base station in wireless communication. In other words, the service end 110 denotes means that can be finally connected to the user terminal 200. Moreover, the service providing unit 130 may be a content provider or the like capable of providing the content, etc., of a communication service. Although the exemplary embodiment of the present invention has been described with respect to an example in which each of the components, i.e., the service end 110, the user authentication unit 120, and the service providing unit 130, are included in the service providing system 100 as explained above, the components described herein may be implemented as separate components.

A terminal for receiving a communication service according to the exemplary embodiment of the present invention will be described with reference to FIG. 4.

FIG. 4 is a structural view of a terminal according to the exemplary embodiment of the present invention.

Herein, for example, the communication service providing system 100 includes a first service providing system and a second service providing system and the terminal for receiving a communication service through the second service providing system in the service area of the first service providing system.

As shown in FIG. 4, a terminal 200 according to the exemplary embodiment of the present invention includes an authentication information providing unit 210, a common authentication information providing unit 220, and a service receiving unit 230.

When the terminal 200 located in the service area of the first service providing system requests connection to the first service providing system, the first service providing system makes a request for authentication information to the terminal 200. Then, the authentication information providing unit 210 of the terminal 200 provides authentication information to the first service providing system.

When the first service providing system requests authentication information upon determining that the terminal 200 located in its service area is a terminal to receive a visiting service, the common authentication information providing unit 220 provides common authentication information to the first service providing system. The thus-provided common authentication information is transmitted to the second service system to approve the authentication of the terminal.

Upon completion of the common authentication for the terminal 200 located in the area of the first service providing system, the service reception unit 230 receives a communication service provided from the second service providing system and provides it to the user.

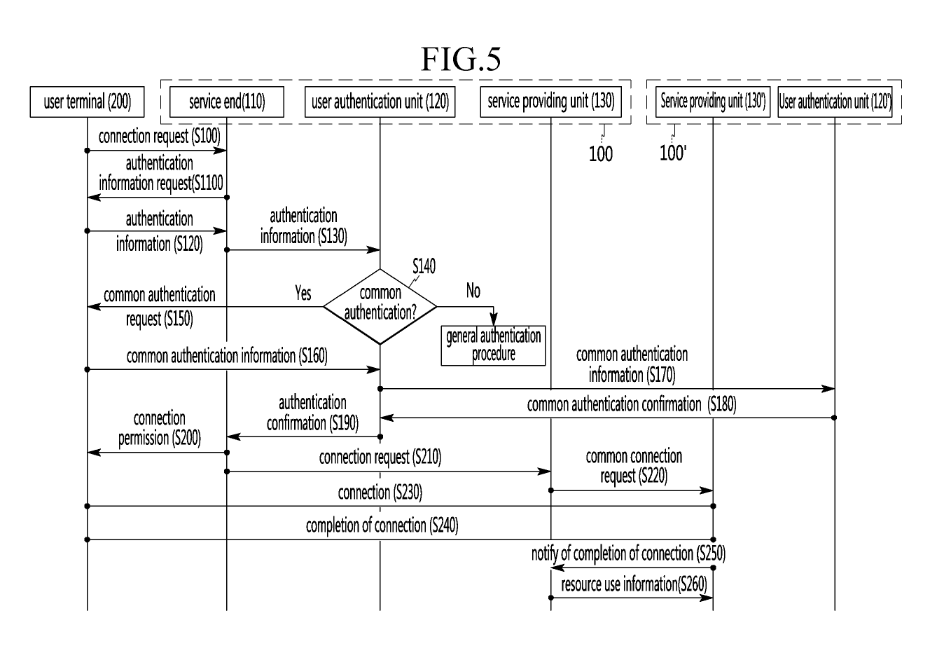

A method for performing the common authentication for the user and providing a communication service to the terminal by using the above-explained communication service providing apparatus will be described with reference to FIG. 5.

FIG. 5 is a flowchart showing a common authentication and connection procedure according to the exemplary embodiment of the present invention.

Prior to explaining FIG. 5, in the exemplary embodiment of the present invention, it is assumed for convenience of explanation that the first service providing system (or referred to as a “visiting service providing system) 100 and the second service providing system (or referred to as a “home service providing system) 100′ include user authentication units 120 and 120′ and service providing units 130 and 130′, respectively. Although it is assumed that the first service providing system 100 and the second service providing system 100′ include service ends 110 and 110′, respectively, the service end 110′ of the second service providing system 100′ is not shown in the drawing for convenience of explanation.

The following is a description of the authentication procedure and connection procedure of a user terminal that allows the user in such an environment to use a communication service through the second service providing system 100′ even in the service area of the first service providing system 100 that is different from that of the second service providing system 100′.

As shown in FIG. 5, when a user terminal 200 is located in the service area (hereinafter referred to as the first service area) of the first service providing system 100, the user terminal 200 requests connection to the service end 110 of the first service providing system 100 in order to use a communication service (S100). Having received a connection request from the user terminal 200, the service end 110 makes a request for authentication information to the user terminal 200 for the authentication of the corresponding user terminal 200 (S110).

The user terminal 200 sends authentication information to the service end 110 of the first service providing system 100 (S120), and the service end 110 having received the authentication information forwards the authentication information of the user terminal 200 to the user authentication unit 120 of the first service providing system 100 (S130). Here, the authentication information is authentication information provided to use a general communication service, and for example, includes login information, certificate information, etc., but is not necessarily limited thereto. The user authentication unit 120 determines whether the user is a home service user or a visiting service user based on the authentication information of the user terminal 200 received in step S130 (S140).

If the user of the user terminal 200 who has requested connection is determined to be a home service user in step S140, the user authentication unit 120 performs the authentication procedure of the user terminal 200. On the other hand, if the user who has requested connection is determined to be a visiting service user, the user authentication unit 120 makes a request to the user terminal 200 for common authentication information of the user (S150).

Here, the common authentication information is composed of a small an amount of information, which is a common part selected from among the information required for the authentication of the user who actually uses the service in a service providing system. Such authentication information minimizes inconsistent information between service providing systems. That is, since different service providing systems authenticate users by different user authentication procedures and methods, they do not work in compatibility with each other. Thus, it is necessary to ensure that information is kept consistent in order for these systems to work in compatibility with each other.

However, each service providing system may have different additional information because each of the service providing systems basically uses common user information for authentication. The present invention will be described with respect to an example in which such common authentication information includes a user identifier, a user authentication code (e.g., encryption code), or a subscription service provider identifier, but this invention is not necessarily limited thereto.

When the user authentication unit 120 receives common authentication information from the user terminal 200 (S160), the user authentication unit 120 forwards the received common authentication information to the user authentication unit 120′ of the second service providing system 100′ (S170). As used herein, the second service providing system 100′ refers to a home service system of the user. The user authentication unit 120′ of the second service providing system 100′ authenticates the user using the common authentication information forwarded from the user authentication unit 120, and sends an authentication result to the user authentication unit 120 of the first service providing system 100 (S180).

Having received the authentication result, the user authentication unit 120 of the first service providing system 100 sends an authentication confirmation message indicative of the confirmation of user authentication to the service end 110 (S190). The service end 110 of the first service providing system sends a message indicative of connection permission to the user terminal 200 that has requested connection (S200), and at the same time, makes a request to the service providing unit 130 of the first service providing system 100 for connection of the user terminal 200 of which connection is permitted (S210).

Then, the service providing unit 130 of the first service providing system 100 makes a request to the service providing unit 130′ of the second service providing system 100′ for a common connection of the user terminal 200 (S220), and accordingly connection is made between the user terminal 200 and the service providing unit 130′ of the second service providing system 100′ (S230). Therefore, the user terminal 200 located in the first service area of the first service providing system 100 is able to receive the service from the service providing unit 130′ of the second service providing system 100′.

When the user terminal 200 completes the use of the service and the connection between the user terminal 200 and the service providing unit 130′ of the second service providing system 100′ is completed, the service providing unit 130′ of the second service providing system 100′ notifies the service providing unit 130 of the first service providing system 100 of completion of the connection (S250). Then, the service providing unit 130 of the first service providing system 100 notifies the service providing unit 130′ of the second service providing system 100′ of resource use information (S260). As used herein, the resource use information means information on resources used in the first service providing system 100 when the user terminal 200 receives a service from the second service providing system 100′. Such remote resource use information is accumulated for a predetermined period of time, and is used as information for accounting between the service providing systems.

As for the accounting method to be used herein, although a method similar to an accounting method for a long-term network lease may be employed, a method separately agreed on between the service providing systems may be selected and used. As the accounting procedure is well-known, a detailed description thereof will be omitted in the exemplary embodiment of the present invention.

According to the exemplary embodiment of the present invention, a user can use a communication service provided from their subscribed communication service provider, irrespective of user location and type of terminal, even in the service area of a communication service provider to which the user has not subscribed.

Moreover, user-friendliness is not reduced because the user can receive an unsubscribed communication service while not realizing it, and information of communication service providers is not disclosed because only common authentication information is exchanged among the communication service providers.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a first service providing system provides a communication service to a terminal in an environment including the first service providing system and a second service providing system, the method comprising:
receiving authentication information by a terminal that has requested connection;
making a request to the terminal for common authentication information based on the received authentication information;
receiving the common authentication information from the terminal and forwarding the same to the second service providing system;
receiving an authentication result of the common authentication information from the second service providing system; and
transmitting a connection permission message to the terminal based on the authentication result and making a request to the second service providing system for connection to the terminal so that the communication service is provided to the terminal through the second service providing system.

2. The method of claim 1, wherein the making of a request for common authentication information comprises:
determining whether the terminal is a visiting user based on the received authentication information; and
if the terminal is a visiting user, making a request to the terminal for common authentication information to perform the authentication of the visiting user.

3. The method of claim 2, further comprising,
if the terminal is not a visiting user,
performing the authentication procedure of the terminal by the first service providing system based on the authentication information.

4. The method of claim 2, wherein the common authentication information comprises any of a user identifier of a user using the terminal, a user authentication code, and a subscription service provider identifier.

5. The method of claim 1, comprising,
after the providing of the service,
receiving a connection complete message from the second service providing system; and
forwarding resource use information provided to the terminal to the second service providing system.

6. A method for providing a communication service to a terminal in an environment including a first service providing system and a second service providing system, the method comprising:
the first service providing system determining whether a terminal that is located in a service provision area of the first service providing system and has requested connection is a visiting user;
if the terminal is a visiting user, the first service providing system forwarding common authentication information received from the terminal to the second service providing system;
the second service providing system performing the authentication of the terminal based on the received common authentication information and sending an authentication result to the first service providing system;
the first service providing system sending a connection permission message to the terminal based on the authentication result and making a connection request to the second service providing system; and
the second service providing system providing the communication service to the terminal by using the resources of the first service providing system;

7. The method of claim 6, wherein the first service providing system is a visiting service providing system of the terminal, and the second service providing system is a home service providing system of the terminal.

8. The method of claim 7, wherein the common authentication information comprises information used equally for the first service providing system and the second service providing system to perform authentication.

9. The method of claim 6, comprising,
after the providing of the communication service:
the second service providing system's sending a message indicative of completion of the connection to the first service providing system; and
the first service providing system's sending, to the second service providing system, resource use information indicating how many resources of the second service providing system the first service providing system has used.

10. An apparatus for providing a communication service to a terminal using common authentication, the apparatus comprising:
a user authentication unit for determining whether the terminal is a visiting user based on authentication information received from the terminal, and if so, performing authentication based on common authentication information received from the terminal; and
a service providing unit for providing a communication service to the terminal upon completion of the authentication of the terminal by the user authentication unit.

11. The apparatus of claim 10, comprising a service provider end for making a request for authentication information to the terminal having requested connection to receive the authentication information, and receiving common authentication information requested by the user authentication unit to provide the same to the user authentication unit.

12. The apparatus of claim 10, wherein the communication service comprises either a connection service, such as telephone, packet communication, or Internet, or a content or application service additionally connected to the connection service.

13. A method for providing a communication service to a terminal in an environment including a first service providing system and a second service providing system, the method comprising:
requesting connection to the first service providing system, and then sending authentication information to the first service providing system;
upon receiving a request for common authentication information from the first service providing system, sending common authentication information to the second service providing system through the first service providing system; and
upon receiving a connection permission message from the first service providing system, receiving the communication service through the second service providing system.

14. The method of claim 13, wherein the first service providing system is a visiting service providing system to which the terminal is connected, and the second service providing system is a home service providing system for the terminal.

15. A terminal for receiving a communication service through a second providing system in an environment including a first service providing system and a second service providing system, the terminal including:
an authentication information providing unit for providing authentication information to the first service providing system upon connection to the first service providing system;
a common authentication information providing unit for, upon receiving a request for common authentication information from the first service providing system, transmitting common authentication information to the first service providing system to be forwarded to the second service providing system; and
a service receiving unit for receiving the communication service provided from the second service providing system.
